(19) United States
(12) Patent Application Publication
(10) Pub. No.: US 2025/0178947 A1
(43) Pub. Date: Jun. 5, 2025

(54) CONTACTLESS GUIDE, MANUFACTURING METHOD OF OPTICAL FIBER, AND MANUFACTURING APPARATUS FOR OPTICAL FIBER

(71) Applicant: SUMITOMO ELECTRIC INDUSTRIES, LTD., Osaka (JP)

(72) Inventors: Satoshi YOSHIKAWA, Osaka (JP); Manabu SHIOZAKI, Osaka (JP)

(21) Appl. No.: 18/842,888

(22) PCT Filed: Mar. 2, 2023
(86) PCT No.: PCT/JP2023/007861

§ 371 Date: Aug. 30, 2024

(30) Foreign Application Priority Data
Mar. 3, 2022 (JP) 2022-032799
Mar. 3, 2022 (JP) 2022-032804

(51) Int. Cl. C03B 37/025; C03B 37/03

(52) U.S. Cl. CPC C03B 37/0253; C03B 37/032; C03B 2205/40; C03B 2205/50

(57) ABSTRACT

A contactless guide includes an inner member having a plurality of ejection ports capable of ejecting a gas in an outer peripheral surface, and a first flange and a second flange housing the inner member so as to sandwich the inner member in a first direction intersecting with an ejection direction of the gas ejected from the plurality of ejection ports. At least one of the first flange and the second flange is attached to the inner member such that a gap through which the gas ejected from the plurality of ejection ports passes is provided between an outer edge portion of the first flange and an outer edge portion of the second flange. At least one of the first flange and the second flange is movable in a direction in which a width of the gap is changed.

### TECHNICAL FIELD

The present disclosure relates to a contactless guide, a manufacturing method of an optical fiber, and a manufacturing apparatus for an optical fiber.

This application claims priority based on Japanese Patent Applications No. 2022-032799 and No. 2022-032804 filed on Mar. 3, 2022, and the entire contents of the Japanese patent applications are incorporated herein by reference.

### BACKGROUND ART

In PTL 1, an example of a manufacturing method of an optical fiber is disclosed. In this manufacturing method, an optical fiber preform is melted and drawn, and a coating layer is provided on the outer peripheral of the drawn bare optical fiber. During the drawing, the direction of the bare optical fiber is changed by a direction changer (contactless guide). PTL 2 and PTL 3 disclose other examples of the contactless guide or a manufacturing method of the optical fiber using the contactless guide. PTL 4 discloses a manufacturing method of the optical fiber. In this manufacturing method of the optical fiber, the bare optical fiber obtained by melting and drawing the optical fiber preform is coated with a resin. Then, the optical fiber coated with the resin is changed in direction by the bottom roller and wound by the winding device. Thus, the optical fiber is manufactured. PTL 5 discloses that the direction of the bare optical fiber is changed by an air guide at any position from a spinning process to a coating process. PTL 6 discloses that, the coating is deformed when the coating of the thermosetting resin is brought into contact with the bottom roller in an uncured state, and therefore, the optical fiber is floated by blowing a fluid from a guide portion of the bottom roller.

### CITATION LIST

### Patent Literature

PTL 1: Japanese Unexamined Patent Application Publication No. 2016-124727
PTL 2: Japanese Unexamined Patent Application Publication No. S62-3037
PTL 3: Japanese Unexamined Patent Application Publication No. 2010-510957
PTL 4: Japanese Unexamined Patent Application Publication No. 2020-147457
PTL 5: Japanese Unexamined Patent Application Publication No. 2016-147771
PTL 6 Japanese Unexamined Patent Application Publication No. 2020-007183

### SUMMARY OF THE INVENTION

The present disclosure provides a contactless guide including an inner member, a first flange, and a second flange. The inner member has a plurality of ejection ports capable of ejecting a gas in an outer peripheral surface. The first flange and the second flange houses the inner member so as to sandwich the inner member in a first direction intersecting with an ejection direction of the gas ejected from the plurality of ejection ports. At least one of the first flange and the second flange is attached to the inner member such that a gap through which the gas ejected from the plurality of ejection ports passes is provided between an outer edge portion of the first flange and an outer edge portion of the second flange. At least one of the first flange and the second flange is movable in a direction in which a width of the gap is changed.

### BRIEF DESCRIPTION OF THE DRAWINGS

FIG. 1 is a schematic view of an optical fiber manufacturing apparatus according to one of the embodiments.

FIG. 2 is a perspective view showing a contactless guide.

FIG. 3 is a disassembled perspective view of the contactless guide shown in FIG. 2 when it is disassembled along a central axis C.

FIG. 4 is a cross-sectional view of the contactless guide taken along line IV-IV shown in FIG. 2.

FIG. 5 is a disassembled perspective view of the inner member of the contactless guide shown in FIG. 2 when it is disassembled along central axis C.

FIG. 6 is an enlarged view of a region A surrounded by a dashed line in the contactless guide shown in FIG. 4.

FIG. 7 is a cross-sectional view of the contactless guide taken along line VII-VII shown in FIG. 2.

FIG. 8 is a schematic view of the manufacturing apparatus for the optical fiber according to the modification.

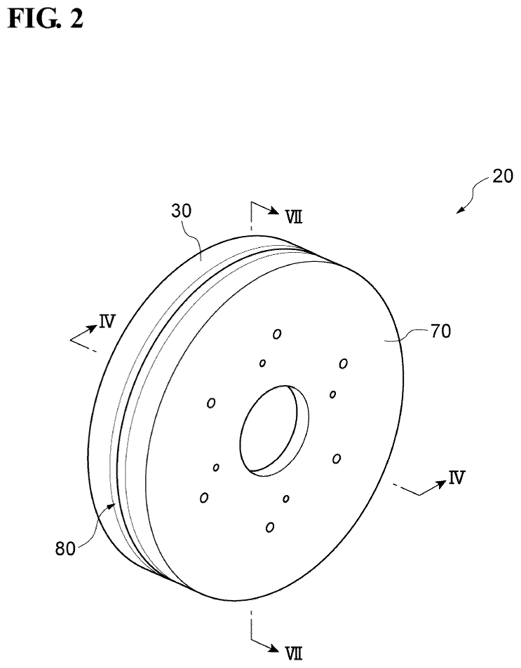

In the modification, FIG. 9 is a cross-sectional view of the contactless guide taken along line VII-VII shown in FIG. 2.

### DETAILED DESCRIPTION

### Problems to be Solved by Present Disclosure

When an optical fiber is manufactured using a contactless guide, a drawn bare optical fiber is passed through a gap provided along the outer peripheral of the contactless guide to change the direction. In this case, the bare optical fiber may be disconnected in the contactless guide, and the disconnected bare optical fiber may be stuck in the gap of the contactless guide. In this case, it is not easy to remove the bare optical fiber that is stuck in the gap. Therefore, the contactless guide that can be easily maintained is desired.

### Advantageous Effects of Present Disclosure

The contactless guide according to the present disclosure can be easily maintained.

### Description of Embodiments of Present Disclosure

First, the contents of embodiments of the present disclosure will be listed and explained. A contactless guide according to one of the embodiments includes a an inner member, a first flange, and a second flange. The inner member has a plurality of ejection ports capable of ejecting a gas in an outer peripheral surface. The first flange and the second flange houses the inner member so as to sandwich the inner member in a first direction intersecting with an ejection direction of the gas ejected from the plurality of ejection ports. At least one of the first flange and the second flange is attached to the inner member such that a gap through which the gas ejected from the plurality of ejection ports passes is provided between an outer edge portion of the first flange and an outer edge portion of the second flange. At least one of the first flange and the second flange is movable in a direction in which a width of the gap is changed.

In this contactless guide, by moving at least one of the first flange and the second flange, the width of the gap for passing the bare optical fiber or the optical fiber (hereinafter, also referred to as “bare optical fiber and the like”) can be widened. This makes it possible to easily perform maintenance of the contactless guide, such as removing the bare optical fiber and the like which is stuck in the gap and cleaning the surfaces of the first flange and the second flange defining the gap. Further, by changing the width of the gap, the pressure of the gas blown out from the contactless guide is adjustable. Therefore, the gas having an appropriate pressure can be blown to the bare optical fiber and the like in accordance with the type and state of the bare optical fiber and the like to be passed through the gap.

As one of the embodiments, the outer peripheral surface of the inner member may have a buffer groove extending in a circumferential direction of the outer peripheral surface. The plurality of ejection ports may be provided in a bottom portion of the buffer groove. The buffer groove may be spatially connected to the gap in the ejection direction. In this case, the gas ejected from the plurality of ejection ports is dispersed in the circumferential direction in the buffer groove, and then blown out from the gap to the outside. That is, the buffer groove reduces the pressure unevenness of the gas blown out from the gap. This makes it possible to more stably change the direction of the bare optical fiber and the like.

As one of the embodiments, the inner member may have a disc shape and may have a gas supply portion to which the gas is supplied from an outside and a plurality of gas flow paths connecting the gas supply portion with the plurality of ejection ports. The gas supply portion may be located in a central portion of the inner member. The plurality of gas flow paths may be provided radially from the gas supply portion to the plurality of ejection ports. The plurality of ejection ports may be located in a circumferential direction of the outer peripheral surface. In this case, since the plurality of ejection ports are not intensively located in a specific region of the outer peripheral surface of the inner member but are dispersedly arranged, the pressure unevenness of the gas blown out from the gap is reduced. This makes it possible to more stably change the direction of the bare optical fiber and the like.

As one of the embodiments, each of the gas flow paths may have a circular cross-section, and an inner diameter on a side of the ejection port may be larger than an inner diameter on a side of the gas supply portion. In this case, by increasing the inner diameter on the side of the ejection port, the pressure unevenness of the gas blown out from the gap is reduced. This makes it possible to more stably change the direction of the bare optical fiber and the like.

As one of the embodiments, the outer peripheral surface of the inner member may include a first columnar surface and a second columnar surface located with the plurality of ejection ports interposed therebetween in the first direction. The first flange may have a first housing portion defined by an inner peripheral surface facing the first columnar surface when housing the inner member. The second flange may have a second housing portion defined by an inner peripheral surface facing the second columnar surface when housing the inner member. A sealing member may be provided between the first columnar surface and the inner peripheral surface of the first housing portion, and a sealing member may be provided between the second columnar surface and the inner peripheral surface of the second housing portion. In this case, the gap between the first columnar surface and the inner peripheral surface of the first housing portion and the gap between the second columnar surface and the inner peripheral surface of the second housing portion are sealed by the sealing member, and the gas injected from the ejection port is prevented from flowing into gaps other than the gap provided between the flanges. That is, the gas supplied to the contactless guide is prevented from flowing into an unintended gap, and the gas can be efficiently used for floating the bare optical fiber and the like.

As one of the embodiments, the contactless guide may further include a seal member sealing at least one of the plurality of ejection ports. In this case, the ejection port can be sealed with the seal member to prevent gas leakage from the ejection port that does not contribute to the floating of the bare optical fiber and the like. That is, the gas supplied to the contactless guide can be efficiently used for floating the bare optical fiber and the like.

As one of the embodiments, at least one of a surface of the outer edge portion of the first flange and a surface of the outer edge portion of the second flange defining the gap may have a Vickers hardness of 800 HV or more. In this case, even when the bare optical fiber and the like comes into contact with the surface of each flange defining the gap, the surface is less likely to be flawed. Therefore, the flow of the gas blown out from the gap is not easily disturbed by the flaw, and the gas is stably blown out. This makes it easy to maintain the floating state of the bare optical fiber and the like passing through the gap.

A manufacturing method of an optical fiber according to one of the embodiments is a manufacturing method of the optical fiber using the contactless guide according to any one of the aspects described above. The manufacturing method of the optical fiber includes, melting an optical fiber preform and drawing a bare optical fiber, cooling the bare optical fiber, and coating the bare optical fiber with a resin to form an optical fiber. The cooling passes the bare optical fiber through the gap of the contactless guide, blows the gas ejected from the ejection ports against the bare optical fiber to float the bare optical fiber, and changes a direction of the bare optical fiber with the contactless guide serving as an axis.

A manufacturing apparatus for an optical fiber according to one of the embodiments is a manufacturing apparatus for the optical fiber using the contactless guide according to any one of the aspects described above. The manufacturing apparatus for the optical fiber includes a melting device configured to melt an optical fiber preform in order to draw a bare optical fiber from the optical fiber preform, a cooling device configured to cool the bare optical fiber, and a coating device configured to coat the bare optical fiber with a resin to form an optical fiber. The cooling device is a device configured to pass the bare optical fiber through the gap of the contactless guide, blow the gas ejected from the ejection ports against the bare optical fiber to float the bare optical fiber, and cool the bare optical fiber.

In the manufacturing method and the manufacturing apparatus for the optical fiber according to the above-described embodiment, the gas is directly blown to the bare optical fiber from the gap of the contactless guide. Thus, the bare optical fiber is efficiently cooled.

In the embodiment of the manufacturing method and the manufacturing apparatus for the optical fiber, at least one of the first flange and the second flange may be moved to adjust the width of the gap. In this case, the width of the gap can be adjusted according to the diameter or type of the bare optical fiber and the like, and the pressure of the gas blown to the bare optical fiber can be maintained at an appropriate level. Thus, the bare optical fiber can be maintained in a floating state.

A manufacturing method of an optical fiber according to another embodiment, is a manufacturing method of the optical fiber using the contactless guide according to any one of the aspects described above. The manufacturing method of the optical fiber according to this another embodiment includes, melting an optical fiber preform and drawing a bare optical fiber, coating the bare optical fiber with a resin to form an optical fiber, and changing a direction of the optical fiber using a bottom roller, and winding the optical fiber using a winding device. In this manufacturing method, the bottom roller is the contactless guide of any aspect described above.

A manufacturing apparatus for an optical fiber according to another embodiment is a manufacturing apparatus for the optical fiber using the contactless guide according to any one of the above-described aspects. The manufacturing apparatus for the optical fiber according to this another embodiment includes, a melting device configured to melt an optical fiber preform in order to draw a bare optical fiber from the optical fiber preform, a cooling device configured to cool the bare optical fiber, a coating device configured to coat the bare optical fiber with a resin to form an optical fiber, a winding device configured to wind the optical fiber, and a bottom roller located between the coating device and the winding device in a path through which the optical fiber passes and configured to change a direction of the optical fiber. The bottom roller is the contactless guide.

In the conventional manufacturing method of the optical fiber, in the bottom roller for changing the direction of the optical fiber, a slight vibration (tilting vibration) may occur due to a deviation between the rotation axis and the verticality of the roller. This slight vibration propagates to the optical fiber guided by the bottom roller and the bare optical fiber connected thereto, and vibrates the bare optical fiber and the like. When the bare optical fiber and the like vibrates, the bare optical fiber which is being coated with the resin is slightly shifted in the horizontal direction from the predetermined path, and the uneven thickness of the coating resin of the optical fiber is caused and the outer diameter varies. Further, there is a possibility that the quality characteristics of the optical fiber may also vary with the variation. In addition, in the conventional roller, the rotational resistance of the bearing is added to the drawing tension, and the rotational resistance of the bearing has an individual difference, and thus there is a possibility that the drawing tension cannot be adjusted to a favorable range. Further, in the manufacturing method of a multicore optical fiber having a plurality of cores in one optical fiber, the optical fiber may roll at the bottom of the groove of the bottom roller due to the tilting vibration of the bottom roller, and may be twisted in the longitudinal direction. When the multicore optical fiber is twisted, for example, it is difficult to cause the plurality of cores to face each other in a correct order and at correct positions when connecting the multicore fibers to each other. In contrast, in the manufacturing method and the manufacturing apparatus for the optical fiber according to the another embodiment, when the optical fiber coated with the resin is wound, the optical fiber is changed in direction by the bottom roller. The bottom roller is a contactless guide roller, and transports the optical fiber without contact. In this case, since the optical fiber does not contact the bottom roller, the vibration from the bottom roller is not propagated to the bare optical fiber and the like. Therefore, according to this another embodiment, it is possible to manufacture the optical fiber in which the fluctuation of the uneven thickness of the coating is suppressed by appropriately coating the resin on bare optical fiber. It is noted that, the contactless guide roller may be a non-rotary guide roller.

In another embodiment of the manufacturing method or the manufacturing apparatus for an optical fiber may further include measuring a drawing tension or a measurement device. In this case, in the winding process or in the control device, the width of the gap of the contactless guide may be adjusted based on the measured drawing tension, and the optical fiber may be wound via the contactless guide. In this case, the optical fiber can be guided by the contactless guide while maintaining an appropriate floating amount by blowing the gas at a blowing pressure corresponding to the drawing tension. Therefore, according to this embodiment, it is possible to manufacture the optical fiber in which the fluctuation of the uneven thickness of the coating and the like is further suppressed.

In another embodiment of the manufacturing method or the manufacturing apparatus for an optical fiber may further include measuring a fiber diameter of the optical fiber or a measurement device. In this case, in the winding process or in the control device, the width of the gap of the contactless guide may be adjusted based on the measured fiber diameter, and the optical fiber may be wound via the contactless guide. In this case, by setting the width of the gap in accordance with the fiber diameter of the optical fiber, the optical fiber can be guided by the contactless guide while maintaining an appropriate floating amount. Therefore, according to this embodiment, it is possible to manufacture an optical fiber in which the fluctuation of the uneven thickness of the coating and the like is further suppressed.

### Details of Embodiments of Present Disclosure

Specific examples of the contactless guide, the manufacturing method of the optical fiber, and the manufacturing apparatus for the optical fiber according to the present disclosure will be described below with reference to the drawings. In the following description, the same elements or elements having the same functions are denoted by the same reference numerals, and redundant description will be omitted. It is noted that, the present invention is not limited to these examples, but is defined by the scope of the claims, and is intended to include all modifications within the meaning and scope equivalent to the scope of the claims.

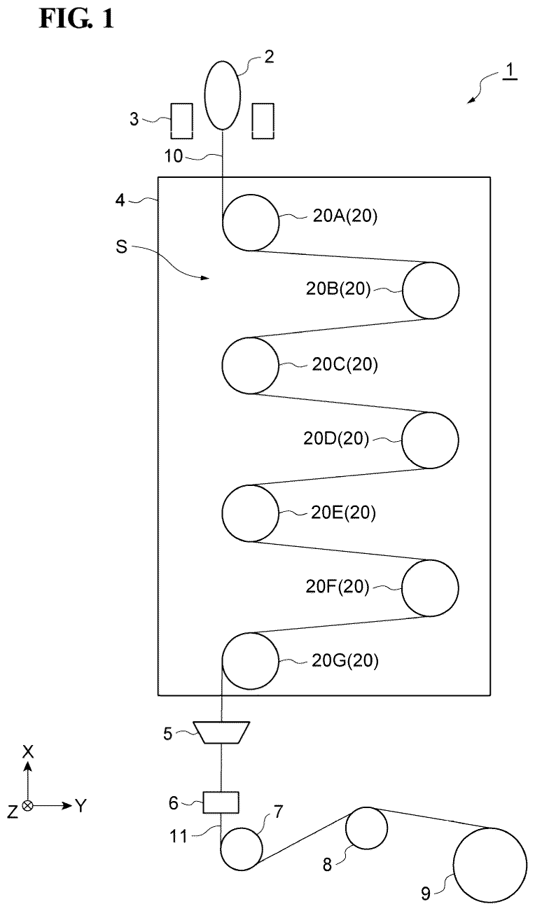

Referring to FIG. 1, the manufacturing method of the optical fiber and the manufacturing apparatus for the optical fiber according to one of the embodiments will be described. FIG. 1 is a schematic view of a manufacturing apparatus 1 for the optical fiber according to one of the embodiments. As shown in FIG. 1, manufacturing apparatus 1 is a apparatus for manufacturing an optical fiber 11 by heating and melting an optical fiber preform 2 to draw a bare optical fiber 10 and providing a coating resin on the outer peripheral of the bare optical fiber 10. Manufacturing apparatus 1 includes a drawing furnace 3, a cooling device 4, a coating device 5, a curing device 6, a bottom roller 7, a pulling roller 8, and a winding device 9 in this order along the path through of the bare optical fiber 10 and the optical fiber 11.

Drawing furnace 3 heats and melts optical fiber preform 2 by enabling to draw along the vertical direction (a direction X shown in FIG. 1) to form bare optical fiber 10. Drawing furnace 3 has a heater located around optical fiber preform 2. Optical fiber preform 2 is a glass body (preform) containing, for example, quartz glass. Bare optical fiber 10 is, for example, a glass wire including a core and a clad covering an outer peripheral of the core. Drawing furnace 3 is configured to draw after the lower end of optical fiber preform 2 is heated and softened by a heater. Drawn bare optical fiber 10 is sent to cooling device 4.

Cooling device 4 cools bare optical fiber 10. Cooling device 4 has, for example, an inner space S surrounded by an outer wall, and bare optical fiber 10 passes through inner space S. The outer wall of cooling device 4 may be made of transparent glass or resin so that the inside of cooling device 4 can be confirmed. Cooling device 4 may have an air inlet (not illustrated) for injecting a dry gas into inner space S to cool bare optical fiber 10. The heat of bare optical fiber 10 is discharged to the outside by using the dry gas as a refrigerant. Cooling device 4 has an exhaust port (not illustrated) for discharging the dry gas. It is noted that, although surrounding with the outer wall makes it possible to manage the dew-point inside cooling device 4 and prevent scattering of optical fibers in the event of wire breakage, it is also possible to simply cool bare optical fiber 10 by a contactless guide 20 described below, without being surrounded by the outer wall. In addition, even when surrounded by the outer wall, bare optical fiber 10 may only be prevented from directly coming into contact with the outside air without injecting the dry gas into inner space S.

Bare optical fiber 10 passes through inner space S in a meandering manner while changing its traveling direction by the plurality of contactless guides 20. Bare optical fiber 10 passes between each of contactless guides 20 in a direction inclined with respect to direction X and a direction Y. In the embodiment, the height direction of manufacturing apparatus 1 is defined as direction X, the width direction is defined as direction Y, and the depth direction is defined as a direction Z. In the embodiment, direction X, direction Y, and direction Z are orthogonal to each other. Cooling device 4 has seven contactless guides 20. Contactless guides 20A, 20B, 20C, 20D, 20E, 20F, and 20G are provided in this order in the moving path of bare optical fiber 10. Hereinafter, when it is not necessary to distinguish each of contactless guides 20, contactless guides 20 will be collectively referred to as contactless guide 20. The number of contactless guides 20 included in cooling device 4 may be plural and is not limited to seven. For example, cooling device 4 may include three to fifteen contactless guides 20.

Each of contactless guides 20 is a member that changes the movement direction of bare optical fiber 10. Contactless guide 20 is a disc-shaped member and bare optical fiber 10 is inserted into a gap 80 (refer to FIG. 2) provided in an outer peripheral portion. Each of contactless guides 20 may be movable along direction Y so as to traverse inner space S, or may be located at a predetermined position without moving. When contactless guide 20 is movable, in the embodiment, three contactless guides 20 (contactless guides 20B, 20D, and 20F) move along direction Y toward the right side of FIG. 1. Bare optical fiber 10 cooled by cooling device 4 is sent to coating device 5. Contactless guide 20 will be described in detail later.

Coating device 5 coats the coating resin on the outer peripheral of bare optical fiber 10. The coating resin is, for example, an ultraviolet curable-type resin. Coating device 5 may coat two different types of coating resins to the outer peripheral of bare optical fiber 10. Coating device 5 may coat, for example, a primary resin layer on bare optical fiber 10, and then coat a secondary resin layer having a higher hardness than the primary resin layer on the outside of the primary resin layer. Coating device 5 may coat the primary resin layer and the secondary resin layer on bare optical fiber 10 substantially at the same time. Bare optical fiber 10 coated with the coating resin is sent to curing device 6.

Curing device 6 cures the coating resin coated on bare optical fiber 10 by irradiating ultraviolet light. Curing device 6 includes a light-emitting device such as an ultraviolet lamp that emits ultraviolet light. The coating resin coated to bare optical fiber 10 is cured, and thus optical fiber 11 is completed. Completed optical fiber 11 is sent to bottom roller 7.

Bottom roller 7 changes the movement direction of optical fiber 11 from a direction along direction X to a predetermined direction. Optical fiber 11 whose movement direction has been changed by bottom roller 7 is sent to pulling roller 8. Pulling roller 8 pulls and moves optical fiber 11. The moving speed of optical fiber 11 may be adjustable by changing the rotational speed of pulling roller 8. Optical fiber 11 is send from pulling roller 8 to winding device 9 and wound by winding device 9. The manufacturing process of optical fiber 11 is thus completed.

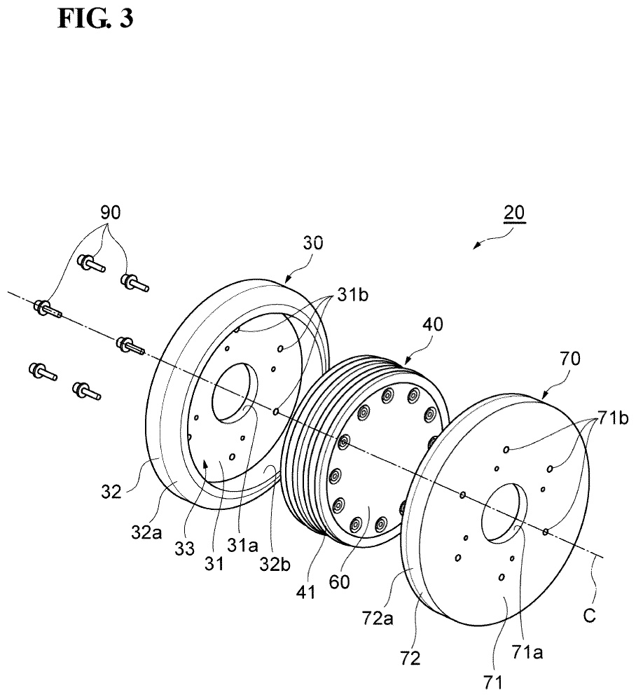

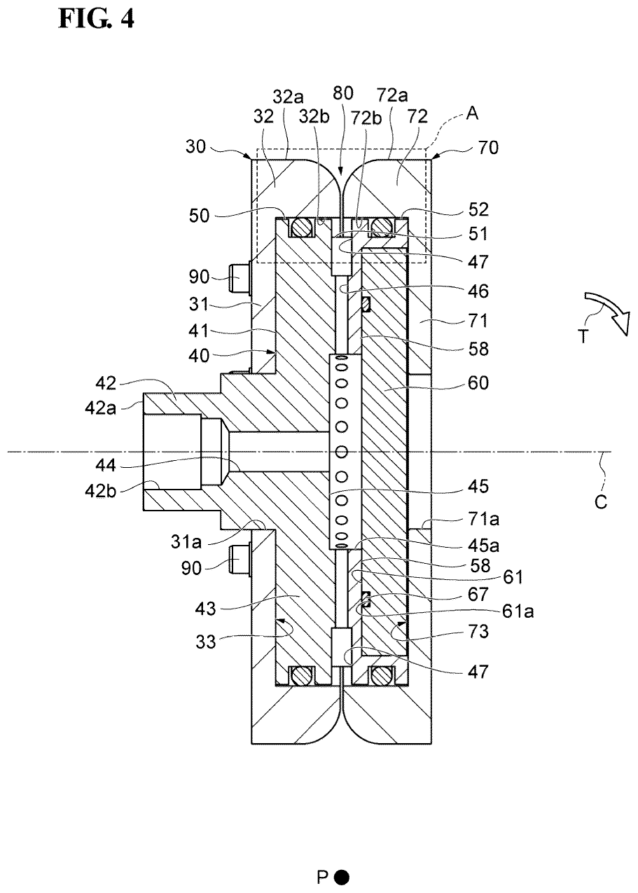

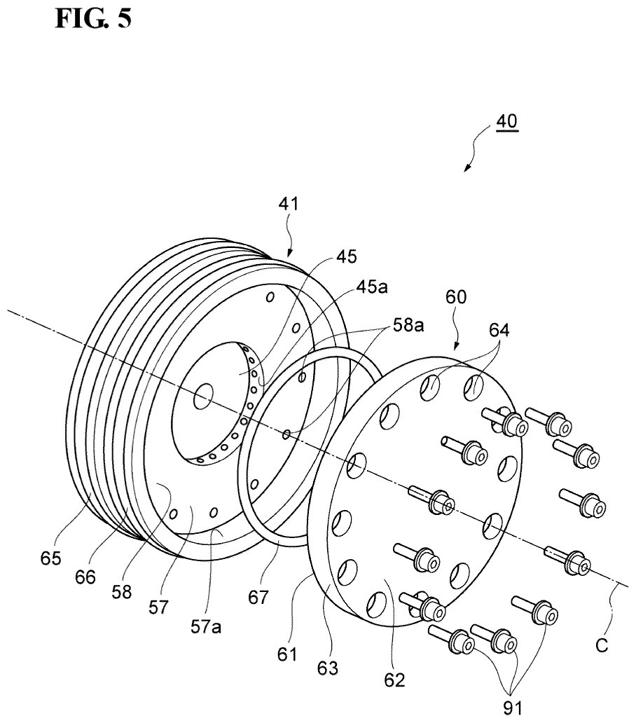

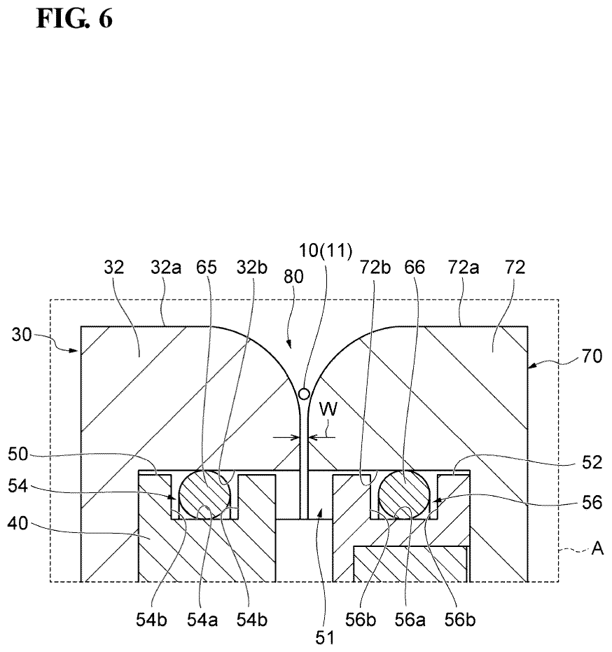

Next, with reference to FIGS. 2 to 6, the structure of contactless guide 20 will be described. FIG. 2 is a perspective view showing contactless guide 20. FIG. 3 is a disassembled perspective view of contactless guide 20 when it is disassembled along central axis C. FIG. 4 is a cross-sectional view of contactless guide 20 taken along line IV-IV shown in FIG. 2. FIG. 5 is a disassembled perspective view of an inner member 40 when it is disassembled along central axis C. FIG. 6 is an enlarged view of region A surrounded by a dashed line shown in FIG. 4.

Contactless guide 20 is a member that changes the movement direction of bare optical fiber 10. Contactless guide 20 has a circular shape in a plan view. As shown in FIG. 2, contactless guide 20 has gap 80 between a first flange 30 and a second flange 70. Gap 80 is provided in a ring shape along the outer peripheral of contactless guide 20. Bare optical fiber 10 is passed through gap 80. The gas introduced into contactless guide 20 is blown out from gap 80 toward the outside. The gas which is blown out is blown against bare optical fiber 10 passed through gap 80. Bare optical fiber 10 floats by the gas blown against it, and is not in contact with first flange 30 and second flange 70. Thus, even when contactless guide 20 is a non-rotary type, the direction of bare optical fiber 10 can be changed without damaging bare optical fiber 10.

As shown in FIG. 3, contactless guide 20 includes first flange 30, inner member 40, and second flange 70. First flange 30 is a member that is provided on a side portion of contactless guide 20 and houses a part of inner member 40. First flange 30 has a disc portion 31 having a circular shape in a plan view and a peripheral wall portion 32 formed along an outer peripheral of disc portion 31. As shown in FIG. 3, disc portion 31 is provided with one hole 3 la and a plurality of screw holes 31b. Hole 31a is a through hole provided at the center of disc portion 31. As shown in FIG. 4, a shaft portion 42 of inner member 40 can be inserted into hole 31a. The plurality of screw holes 31b are through holes with a small diameter provided in a scattered manner so as to surround hole 31a. The plurality of screws 90 can be inserted into the plurality of screw holes 31b, respectively. First flange 30 is fixed to inner member 40 by screw 90.

Peripheral wall portion 32 has an outer peripheral surface 32a facing the outside of first flange 30 and an inner peripheral surface 32b facing the inside of first flange 30 (the side of a first housing portion 33 described later). As shown in FIG. 4, the end portion of outer peripheral surface 32a located at second flange 70 side is curved inward toward central axis C and is connected to the end portion of inner peripheral surface 32b. That is, the end portion of outer peripheral surface 32a has a curved shape in the sectional view. Gap 80 through which bare optical fiber 10 passes is provided between outer peripheral surface 32a and an outer peripheral surface 72a of second flange 70 described later. The surface of the outer edge portion of first flange 30 defining gap 80 (in the embodiment, outer peripheral surface 32a) may have a Vickers hardness of, for example, 800 HV or more, and more preferably 1500 HV or more. The Vickers hardness is measured based on JIS Z2244: 2009. Specifically, a diamond indenter of a square pyramid is pressed into the surface of the sample (in the embodiment, outer peripheral surface 32a), and the Vickers hardness is obtained from the diagonal length of the indentation remaining on the surface.

First flange 30 has first housing portion 33 in which a part of inner member 40 is housed. First housing portion 33 is a substantially cylindrical space defined by the surface of disc portion 31 and inner peripheral surface 32b of peripheral wall portion 32. In a state where inner member 40 is housed in first housing portion 33, as shown in FIG. 4, inner peripheral surface 32b of peripheral wall portion 32 faces a first columnar surface 50 of inner member 40.

Inner member 40 is a member that blows out the introduced gas from gap 80 between first flange 30 and second flange 70 to the outside. Inner member 40 has a disc shape. As shown in FIG. 5, inner member 40 includes a main body portion 41 and a plate 60. As shown in FIG. 4, main body portion 41 has shaft portion 42 extending along central axis C and a columnar portion 43 provided at one end of shaft portion 42. A first gas flow path 44 extending along central axis C is formed inside shaft portion 42. First gas flow path 44 has an opening 42b at an end surface 42a of shaft portion 42. Opening 42b is connected to a gas supply source (an air pump and the like) on the outside. The gas supplied from the gas supply source flows into first gas flow path 44 through opening 42b. The gas supplied from the gas supply source may be, for example, a dry gas filling inner space S (refer to FIG. 1) of cooling device 4. An end portion of first gas flow path 44 located on the opposite side to opening 42b is connected to a flow path branching portion 45 (gas supply portion) included in columnar portion 43. The gas flowing into first gas flow path 44 is supplied to flow path branching portion 45. First gas flow path 44 is formed such that the inner diameter thereof decreases in a stepwise manner from opening 42b side toward flow path branching portion 45 side.

Columnar portion 43 is a substantially columnar member, and is housed so as to be sandwiched between first housing portion 33 and a second housing portion 73 described later. Columnar portion 43 has flow path branching portion 45, a plurality of second gas flow paths 46, and a plurality of ejection ports 47. Flow path branching portion 45 is an inner space having a substantially cylindrical shape, and branches the flow direction of the gas supplied from first gas flow path 44 into a plurality of directions. An inner peripheral surface 45a defining flow path branching portion 45 is provided with a plurality of openings at equal intervals along the circumferential direction. The plurality of openings are connected to the plurality of second gas flow paths 46, respectively.

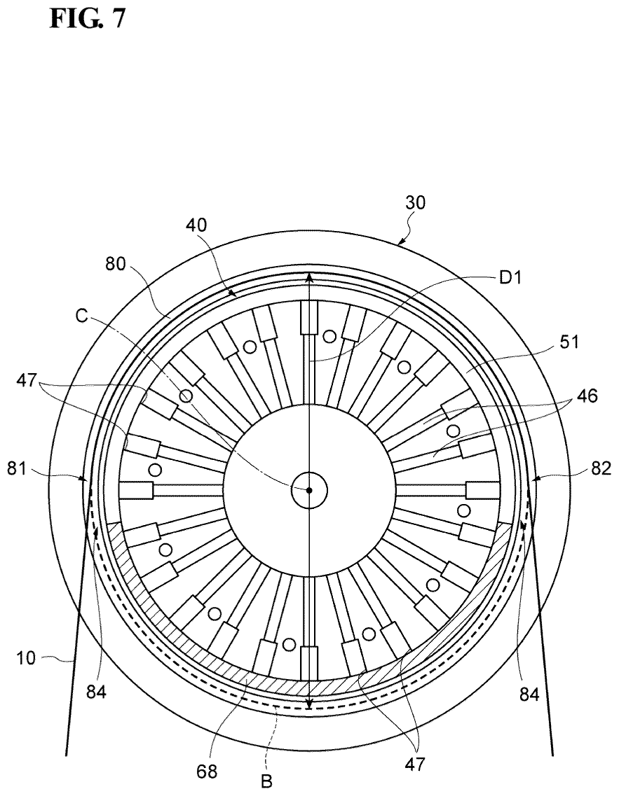

The plurality of second gas flow paths 46 are radially provided from flow path branching portion 45 toward the outer peripheral surface of columnar portion 43 (refer to FIG. 7). One end of second gas flow path 46 is connected to the opening provided in inner peripheral surface 45a as described above, and the other end is connected to ejection port 47 provided in the outer peripheral surface of columnar portion 43. A plurality of ejection ports 47 are provided at equal intervals along the outer peripheral surface. The gas supplied from first gas flow path 44 is branched after staying in flow path branching portion 45, and flows into second gas flow path 46. The gas flowing into second gas flow path 46 is ejected from ejection port 47. The gas ejected from ejection port 47 is blown to bare optical fiber 10 from gap 80 via a buffer groove 51 described later. In the embodiment, the cross-section of second gas flow path 46 is a circular shape. A portion of second gas flow path 46 located on ejection port 47 side is formed to have a larger inner diameter than a portion located on inner peripheral surface 45a side. The shape of second gas flow path 46 is not limited to the above-described shape. The cross-section of second gas flow path 46 may have an elliptical shape or a polygonal shape. Second gas flow path 46 may be a straight flow path having a constant cross-sectional area.

As shown in FIG. 4, the outer peripheral surface of columnar portion 43 has first columnar surface 50, buffer groove 51, and a second columnar surface 52 in this order along central axis C. First columnar surface 50 is located closer to shaft portion 42 than buffer groove 51. In a state where inner member 40 is housed in first housing portion 33, first columnar surface 50 faces inner peripheral surface 32b of peripheral wall portion 32. First columnar surface 50 has a first groove portion 54 as shown in FIG. 6. First groove portion 54 is a recessed portion recessed toward the inside of inner member 40 (toward central axis C shown in FIG. 4), and is provided continuously in an annular shape along first columnar surface 50. First groove portion 54 is a bottomed rectangular groove, and is defined by a bottom surface 54a and a pair of side surfaces 54b facing each other.

A first sealing member 65 is fitted into first groove portion 54. First sealing member 65 may be, for example, an O-ring made of resin having elasticity. First sealing member 65 seals a gap between first columnar surface 50 and inner peripheral surface 32b of peripheral wall portion 32 to prevent the gas ejected from ejection port 47 from flowing into the gap. The width (the distance between the pair of side surfaces 54b) of first groove portion 54 in the direction along central axis C is formed to be slightly larger than the width of the cross-section of first sealing member 65. Thus, first flange 30 can be smoothly moved with respect to inner member 40.

Buffer groove 51 is a recessed portion recessed toward central axis C, and is continuously provided in an annular shape along the outer peripheral surface of inner member 40. Buffer groove 51 is a bottomed rectangular groove, and a plurality of ejection ports 47 are provided on the bottom surface. Buffer groove 51 disperses the gas ejected from the plurality of ejection ports 47 in the circumferential direction (or temporarily retains the gas), and then blows the gas from gap 80 between first flange 30 and second flange 70 to the outside.

Second columnar surface 52 is located farther from shaft portion 42 than buffer groove 51. In a state where inner member 40 is housed in second housing portion 73 described later, second columnar surface 52 faces an inner peripheral surface 72b of a peripheral wall portion 72. Second columnar surface 52 has a second groove portion 56 as shown in FIG. 6. Second groove portion 56 is a recessed portion recessed toward the inside of inner member 40 (toward central axis C shown in FIG. 4), and is provided continuously in an annular shape along second columnar surface 52. Second groove portion 56 is a bottomed rectangular groove, and is defined by a bottom surface 56a and a pair of side surfaces 56b facing each other.

A second sealing member 66 is fitted into second groove portion 56. Second sealing member 66 may be, for example, an O-ring made of resin having elasticity. Second sealing member 66 seals a gap between second columnar surface 52 and inner peripheral surface 72b of peripheral wall portion 72 to prevent the gas ejected from ejection port 47 from flowing into the gap. The width (the distance between the pair of side surfaces 56b) of second groove portion 56 in the direction along central axis C is formed to be slightly larger than the width of the cross-section of second sealing member 66. Thus, second flange 70 can be smoothly moved with respect to inner member 40.

Inner member 40 has a plate housing portion 57 as shown in FIG. 5. Plate housing portion 57 is a substantially cylindrical space capable of housing plate 60. The inner diameter of plate housing portion 57 is larger than the inner diameter of flow path branching portion 45. An inner peripheral surface 57a defining plate housing portion 57 and inner peripheral surface 45a defining flow path branching portion 45 are connected by an inner side surface 58. Inner side surface 58 has an extent along a plane perpendicular to central axis C, and is provided in an annular shape so as to surround central axis C. Inner side surface 58 is provided with a plurality of screw holes 58a to which a plurality of screws 91 for fixing plate 60 to main body portion 41 are respectively attached.

As shown in FIG. 5, plate 60 is a plate member having a circular shape in a plan view. Plate 60 is housed in plate housing portion 57 of main body portion 41. Plate 60 has a first side surface 61, a second side surface 62, and an outer peripheral surface 63. First side surface 61 and second side surface 62 are surfaces that form side surfaces of plate 60 in the direction along central axis C. Outer peripheral surface 63 is a surface that connects the outer edge of first side surface 61 and the outer edge of second side surface 62. In a state where plate 60 is housed in plate housing portion 57, a region of first side surface 61 which is closer to outer peripheral surface 63 is in contact with inner side surface 58 of plate housing portion 57. In addition, the central region of first side surface 61 does not contact inner side surface 58 and functions as a wall surface defining flow path branching portion 45.

As shown in FIG. 4, a third groove portion 61a is provided on first side surface 61. Third groove portion 61a is provided continuously in a ring shape so as to surround central axis C. Third groove portion 61a is a bottomed rectangular groove, and a third sealing member 67 is fitted therein. Third sealing member 67 may be, for example, an O-ring made of resin having elasticity. Third sealing member 67 seals a gap between inner side surface 58 and first side surface 61 to prevent the gas supplied to flow path branching portion 45 from leaking to the outside through the gap.

As shown in FIG. 5, plate 60 is provided with a plurality of through holes 64 penetrating from first side surface 61 to second side surface 62. The plurality of through holes 64 are arranged in a ring shape surrounding central axis C. A plurality of screws 91 are inserted into the plurality of through holes 64, respectively. The tip portion of screw 91 inserted into through hole 64 is attached to screw hole 58a of main body portion 41. Thus, plate 60 is fixed to main body portion 41 in a state where plate 60 is housed in plate housing portion 57.

Second flange 70 is a member that is provided on a side portion of contactless guide 20 and houses a part of inner member 40. Second flange 70 has the similar configuration as first flange 30. As shown in FIG. 3, second flange 70 may be located on the opposite side of first flange 30 in the direction along central axis C, and may be attached to inner member 40 in a direction reversed from first flange 30. That is, in the embodiment, since one flange can be used for both first flange 30 and second flange 70, it is not necessary to prepare flanges having different shapes for first flange 30 and second flange 70.

Second flange 70 has a disc portion 71 having a circular shape in a plan view and peripheral wall portion 72 formed along the outer peripheral of disc portion 71. As shown in FIG. 3, disc portion 71 is provided with one hole 71a and a plurality of screw holes 71b. Hole 71a is a through hole provided at the center of disc portion 71. The plurality of screw holes 71b are through holes, each with a small diameter and are provided in a dotted manner so as to surround hole 31a. When second flange 70 is replaced with first flange 30, shaft portion 42 of inner member 40 can be inserted into hole 71a, and the plurality of screws 90 can be inserted into the plurality of screw holes 71b.

Peripheral wall portion 72 has outer peripheral surface 72a facing the outside of second flange 70 and inner peripheral surface 72b facing the inside (the side of second housing portion 73 described later) of second flange 70. As shown in FIG. 4, an end portion of outer peripheral surface 72a located at first flange 30 side is curved inward toward central axis C and is connected to an end portion of inner peripheral surface 72b. That is, the end portion of outer peripheral surface 72a has a curved shape in the sectional view. As described above, gap 80 through which bare optical fiber 10 passes is provided between outer peripheral surface 72a of second flange 70 and outer peripheral surface 32a of first flange 30. The surface (in the embodiment, outer peripheral surface 72a) of the outer edge portion of second flange 70 defining gap 80 may have a Vickers hardness of, for example, 800 HV or more, and more preferably 1500 HV or more. The method of measuring the Vickers hardness is the same as the method of measuring the Vickers hardness of the surface of first flange 30 described above.

Second flange 70 has second housing portion 73 in which a part of inner member 40 is housed. Second housing portion 73 is a substantially cylindrical space defined by the surface of disc portion 71 and inner peripheral surface 72b of peripheral wall portion 72. In a state where inner member 40 is housed in second housing portion 73, as shown in FIG. 4, inner peripheral surface 72b of peripheral wall portion 72 faces second columnar surface 52 of inner member 40. Second flange 70 is not fixed to inner member 40, and is movable with respect to inner member 40. Second flange 70 may be detachable from inner member 40. Since second flange 70 is detachable, maintenance of gap 80 (removal of bare optical fiber 10 stuck in gap 80, checking of a flaw generated in outer peripheral surfaces 32a and 72a, and the like) can be easily performed.

The configuration of contactless guide 20 when bare optical fiber 10 is inserted into gap 80 will be described with reference to FIG. 6 and FIG. 7. FIG. 7 is a cross-sectional view of contactless guide 20 taken along line VII-VII shown in FIG. 2. First flange 30 and second flange 70 are attached to inner member 40 such that gap 80 is provided between the outer edge portion of first flange 30 and the outer edge portion of second flange 70, as shown in FIG. 6. In the embodiment, gap 80 is provided between outer peripheral surface 32a of first flange 30 and outer peripheral surface 72a of second flange 70.

As shown in FIG. 7, gap 80 is provided along the circumferential direction of contactless guide 20 so as to surround central axis C. Bare optical fiber 10 is passed through gap 80. Specifically, bare optical fiber 10 enters gap 80 from a wire inlet portion 81, moves along gap 80, and then exits to the outside from a wire outlet portion 82. In the example shown in FIG. 7, bare optical fiber 10 moves in a region of about one-half of gap 80 in the circumferential direction. That is, the movement direction of bare optical fiber 10 is changed by about 180° by contactless guide 20. The positions of wire inlet portion 81 and wire outlet portion 82 are determined by the amount of change in the movement direction of bare optical fiber 10. In the embodiment, the movement direction of bare optical fiber 10 is changed by about 180° as described above. Therefore, wire outlet portion 82 is set at a position shifted from wire inlet portion 81 by a length of about one-half of the circumferential length of gap 80. For example, when the movement direction of bare optical fiber 10 is changed by about 90°, wire outlet portion 82 may be set at a position (the uppermost portion of gap 80 in FIG. 7) shifted from wire inlet portion 81 by a length of about one-quarter of the circumferential length of gap 80.

As shown in FIG. 6, gap 80 is spatially connected to buffer groove 51 and ejection port 47. Accordingly, the gas ejected from ejection port 47 passes through buffer groove 51 and is blown out from gap 80 to the outside of contactless guide 20. The gas blown out from gap 80 is blown against bare optical fiber 10 passed through gap 80. Bare optical fiber 10 is maintained in a floating state from outer peripheral surface 32a of first flange 30 and outer peripheral surface 72a of second flange 70 by the wind pressure of the gas. That is, bare optical fiber 10 is in a floating state in gap 80.

Second flange 70 is not fixed to inner member 40, and is movable in a direction in which a width W of gap 80 is changed. Width W of gap 80 is the distance between the closest portions of outer peripheral surface 32a of first flange 30 and outer peripheral surface 72a of second flange 70, which face each other. The method of moving second flange 70 is not limited. As an example, width W of gap 80 may be changed by moving second flange 70 in a direction along central axis C. As another example, width W of gap 80 may be changed by rotating second flange 70 in the direction of an arrow T around a virtual point P as a center shown in FIG. 4. In this case, width W of gap 80 changes so that width W of a portion (lower part in FIG. 4) close to virtual point P decreases and width W of a portion (upper part in FIG. 4) far from virtual point P increases.

The pressure (blowing pressure) of the gas blown out from gap 80 varies depending on factors such as the pressure (inlet pressure) of the gas supplied to first gas flow path 44 (refer to FIG. 4), width W of gap 80, and the like, and is also affected by factors such as a winding diameter D1 of contactless guide 20, and the like. Here, winding diameter D1 refers to the diameter of a circle (circle B indicated by a solid line and a dashed line in FIG. 7) formed by bare optical fiber 10 when bare optical fiber 10 is passed through the entire circumference of gap 80. The blowing pressure is optimized by adjusting the above-described factors (the width of the groove) according to the tension of bare optical fiber 10, the fiber diameter of bare optical fiber 10, and the like.

In general, in the process of increasing the drawing speed (moving speed) of bare optical fiber 10, when the tension applied to bare optical fiber 10 is small and the pressure of the blown gas is high, bare optical fiber 10 resonates and comes into contact with contactless guide 20. Therefore, the blowing pressure is reduced in the process of increasing the drawing speed of bare optical fiber 10. On the other hand, when the drawing speed is stable, the tension of bare optical fiber 10 is maintained high, and thus the blowing pressure is increased. As a method of increasing the blowing pressure, for example, a method of increasing the inlet pressure or decreasing width W of gap 80 can be adopted.

For example, when bare optical fiber 10 having a radius of 125 μm is floated, width W of gap 80 is adjusted so that the entrance pressure is in an optimum range of 50 kPa to 200 kPa. In this case, the flow rate of the gas blown out from gap 80 of one contactless guide 20 may be 30 L/min to 150 L/min.

When the blowing pressure is adjusted to an appropriate value, first, in a state where a gas is allowed to flow at a constant flow rate, width W of gap 80 is reduced until the inlet pressure reaches a predetermined value (for example, 200 kPa). At this time, for example, width W of gap 80 may be reduced by bringing second flange 70 closer to first flange 30. Thereafter, width W of gap 80 is gradually increased until the blowing pressure reaches an optimal value (a value at which bare optical fiber 10 appropriately floats). At this time, for example, width W of gap 80 may be increased by separating second flange 70 from first flange 30. The blowing pressure adjustment operation may be performed on each contactless guide 20 shown in FIG. 1. In addition, the adjustment operation may be performed at any timing in the manufacturing process of optical fiber 11.

Contactless guide 20 has a seal member 68 as shown in FIG. 7. For convenience of explanation, seal member 68 is not shown in the drawings other than FIG. 7. Seal member 68 seals at least one of the plurality of ejection ports 47 and prevent the gas from passing through ejection port 47. Seal member 68 may be made of an elastic material such as resin. Seal member 68 has an elongated shape and is fitted into a region of a part of buffer groove 51 so as to close ejection port 47. In the embodiment, seal member 68 is fitted into the region of approximately half of buffer groove 51. The gas does not flow into some of second gas flow paths 46 in which ejection ports 47 are sealed by seal member 68, and the gas flows into other second gas flow paths 46 in which ejection ports 47 are not sealed.

In a direction (radial direction of contactless guide 20) from central axis C toward the outer peripheral of contactless guide 20, most of seal member 68 is provided so as not to overlap bare optical fiber 10 passing through gap 80. In the example shown in FIG. 7, the portion of seal member 68 excluding the both end portions are provided so that the position in the circumferential direction does not overlap bare optical fiber 10 passed through gap 80. In addition, a pair of gas escape portions 84 through which the gas in buffer groove 51 flows out are provided between the both end portions of seal member 68 and bare optical fiber 10. Since the gas accumulated in buffer groove 51 smoothly flows out from gas escape portion 84, the gas of an excessively high pressure is not blown out from gap 80, and bare optical fiber 10 can be floated in a stable state. The shape of seal member 68 is not limited to the above-described shape. In the embodiment, the plurality of ejection ports 47 are sealed by one continuous seal member 68, but the plurality of ejection ports 47 may be respectively sealed by a plurality of seal members 68 which are separated from each other, for example.

As described above, according to contactless guide 20 of the embodiment, the width of gap 80 can be increased by moving at least one of first flange 30 and second flange 70. This makes it possible to easily perform maintenance of contactless guide 20, such as removing bare optical fiber 10 which is stuck in gap 80 and cleaning the surfaces of first flange 30 and second flange 70 defining gap 80. Further, by changing the width of gap 80, the pressure of the gas blown out from contactless guide 20 is adjustable. Therefore, the gas having an appropriate pressure can be blown against bare optical fiber 10 in accordance with the type and state of bare optical fiber 10 to be passed through gap 80.

Although the embodiments of the present disclosure have been described in detail, the present invention is not limited to the embodiments described above, and can be applied to various embodiments.

For example, first flange 30 may not be fixed to inner member 40, but may be movably attached to inner member 40. In this case, width W of gap 80 may be adjusted by moving first flange 30 together with second flange 70 or instead of second flange 70. By fixing one of first flange 30 and second flange 70 to inner member 40, a moving mechanism for moving the flange can be simplified. At least one of first flange 30 and second flange 70 may be movable with respect to inner member 40, and in the case where first flange 30 is fixed to inner member 40 and second flange 70 is movable with respect to inner member 40, the moving mechanism for moving the flange can be further simplified.

### Modification

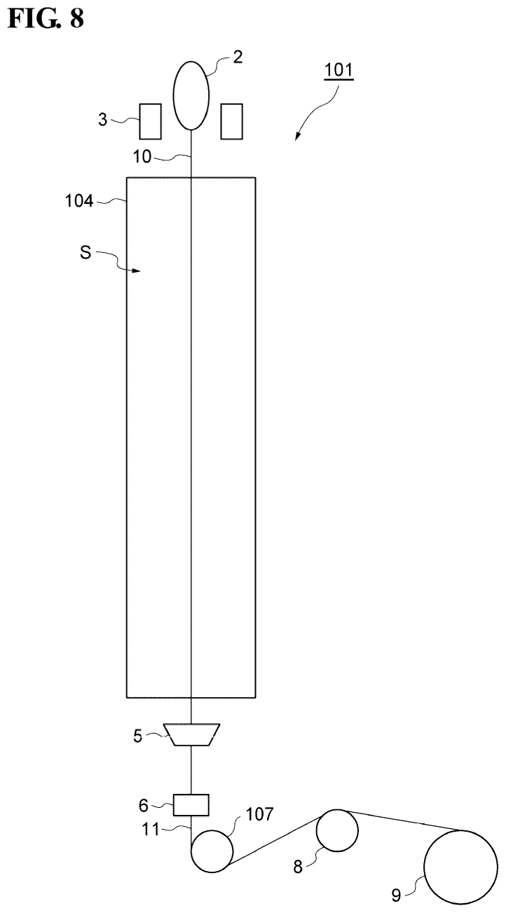

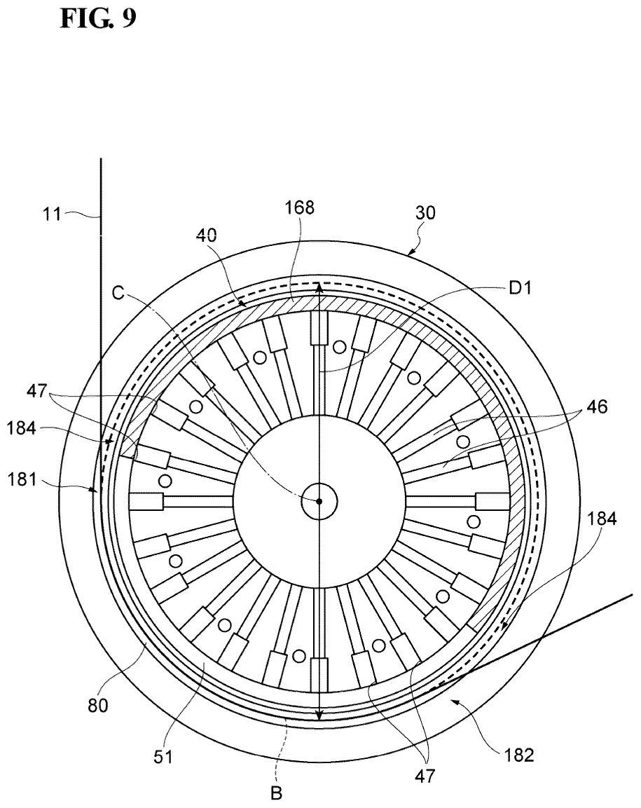

Modifications of manufacturing method of the optical fiber and manufacturing apparatus for the optical fiber according to one of the embodiments of the present disclosure will be described with reference to FIG. 8. FIG. 8 is a schematic view of a manufacturing apparatus for an optical fiber according to the modification. A manufacturing apparatus 101 includes drawing furnace 3, a cooling device 104, coating device 5, curing device 6, a bottom roller 107, pulling roller 8, and winding device 9 in this order along the path through of bare optical fiber 10 and optical fiber 11. In manufacturing apparatus 101, as in manufacturing apparatus 1, optical fiber preform 2 is heated and melted to draw bare optical fiber 10, and bare optical fiber 10 is cooled to a predetermined temperature by cooling device 104. Then, the outer peripheral of cooled bare optical fiber 10 is coated with a resin by coating device 5 and the resin is cured by curing device 6 to form optical fiber 11. Then, optical fiber 11 is changed in direction by bottom roller 107, and optical fiber 11 is wound by winding device 9. In the manufacturing method and manufacturing apparatus 101 for an optical fiber according to this modification, the above-described contactless guide 20 is applied to bottom roller 107. The other configurations of manufacturing apparatus 101 are substantially the same as those of manufacturing apparatus 1 for an optical fiber described above, and thus the overlapping description will be omitted. However, the cooling device used may be general cooling device 104 or cooling device 4 using contactless guide 20 described above.

Cooling device 104 cools bare optical fiber 10. Cooling device 104 has, for example, inner space S surrounded by an outer wall, and bare optical fiber 10 passes through inner space S. The outer wall of cooling device 104 may be made of transparent glass or resin so that the inside of cooling device 104 can be confirmed. Cooling device 104 may have an inlet (not illustrated) for injecting a cooling gas into inner space S to cool bare optical fiber 10. The heat of bare optical fiber 10 is discharged to the outside by using the cooling gas as a refrigerant. Cooling device 104 may have an exhaust port (not illustrated) for discharging the cooling gas.

Coating device 5 coats the coating resin on the outer peripheral of bare optical fiber 10 cooled to a predetermined temperature by cooling device 104. In addition, curing device 6 cures the coating resin coated on bare optical fiber 10 by irradiating ultraviolet light, thereby forming optical fiber 11. Optical fiber 11 thus completed is sent to bottom roller 107. It is noted that, a measurement device may be provided immediately after curing device 6 to measure the fiber diameter of optical fiber 11 in which the coating resin is cured.

Bottom roller 107 is a non-rotary roller that is on the drawing direction (vertical direction) connecting optical fiber preform 2 and coating device 5 and is located directly under coating device 5 and curing device 6, and changes the movement direction of optical fiber 11 from the vertical direction to a predetermined direction. Optical fiber 11 whose movement direction has been changed by bottom roller 107 is sent to pulling roller 8. Pulling roller 8 pulls and moves optical fiber 11. The moving speed of optical fiber 11 can be adjusted by changing the rotational speed of pulling roller 8. Optical fiber 11 is send from pulling roller 8 to winding device 9 and wound by winding device 9. It is noted that, a tension meter may be provided before pulling roller 8 to measure the drawing tension of bare optical fiber 10 or optical fiber 11.

Bottom roller 107 is a disc-shaped member formed of contactless guide 20 (refer to FIG. 2) which is a non-rotary guide roller, and optical fiber 11 is passed through gap 80 provided along the outer peripheral surface. As described above, gap 80 has a groove shape and functions as a guide portion around which optical fiber 11 can be wound in a contactless state without rotation. The width of gap 80 may be adjustable based on the fiber diameter or the drawing tension of optical fiber 11 to be guided. Inside gap 80, a plurality of ejection ports 47 (refer to FIG. 4) for blowing out gas for floating optical fiber 11 are provided. Bottom roller 107 guides optical fiber 11 in a non-rotating and contactless state by blowing gas outward from ejection port 47, and changes the direction of optical fiber 11. The contactless roller applied to bottom roller 107 may have a configuration different from that of contactless guide 20 as long as the direction of optical fiber 11 to be guided can be changed in the contactless state.

Next, with reference to FIG. 6 and FIG. 9, a description will be given of the configuration of contactless guide 20 when optical fiber 11 is passed through gap 80, according to manufacturing apparatus 101 of the present modification. FIG. 9 is a cross-sectional view of contactless guide 20 applied to the present modification, taken along line VII-VII shown in FIG. 2. First flange 30 and second flange 70 are attached to inner member 40 such that gap 80 is provided between the outer edge portion of first flange 30 and the outer edge portion of second flange 70, as shown in FIG. 6. In the modification, gap 80 is provided between outer peripheral surface 32a of first flange 30 and outer peripheral surface 72a of second flange 70.

As shown in FIG. 9, gap 80 is provided along the circumferential direction of contactless guide 20 so as to surround central axis C. Optical fiber 11 is passed through gap 80. Specifically, optical fiber 11 enters gap 80 from a wire inlet portion 181, moves along gap 80, and then exits to the outside from a wire outlet portion 182. In the example shown in FIG. 9, optical fiber 11 moves in a region of about one-third of gap 80 in the circumferential direction. That is, the movement direction of optical fiber 11 is changed by about 120° by contactless guide 20. The positions of wire inlet portion 181 and wire outlet portion 182 are determined by the amount of change in the movement direction of optical fiber 11. In the present modification, the movement direction of optical fiber 11 is changed by about 120° as described above. Therefore, wire outlet portion 182 is set at a position shifted from wire inlet portion 181 by a length of about one-third of the circumferential length of gap 80. For example, when the movement direction of optical fiber 11 is changed by about 90°, wire outlet portion 182 may be set at a position (lower portion of gap 80 in FIG. 9) shifted from wire inlet portion 181 by a length of about one-quarter of the circumferential length of gap 80.

As shown in FIG. 6, gap 80 is spatially connected to buffer groove 51 and ejection port 47. Accordingly, the gas ejected from ejection port 47 passes through buffer groove 51 and is blown out from gap 80 to the outside of contactless guide 20. The gas blown out from gap 80 is blown against optical fiber 11 passed through gap 80. Optical fiber 11 is maintained in a floating state from outer peripheral surface 32a of first flange 30 and outer peripheral surface 72a of second flange 70 by the wind pressure of the gas. That is, optical fiber 11 is in a floating state in gap 80.

The pressure (blowing pressure) of the gas blown out from gap 80 varies depending on factors such as the pressure (inlet pressure) of the gas supplied to first gas flow path 44 (refer to FIG. 4) and width W of gap 80, and the like, and is also affected by factors such as winding diameter D1 of contactless guide 20, and the like. Here, winding diameter D1 refers to a diameter of a circle (circle B indicated by a solid line and a dashed line in FIG. 9) formed by optical fiber 11 when optical fiber 11 is passed through the entire circumference of gap 80. The blowing pressure is optimized by adjusting the above-mentioned factors (groove width) according to the tension (drawing tension) of optical fiber 11 or the fiber diameter of optical fiber 11.

In general, in the process of increasing the drawing speed (moving speed) of optical fiber 11, when the tension applied to optical fiber 11 is small and the pressure of the gas blown is high, optical fiber 11 resonates and comes into contact with contactless guide 20. Therefore, the blowing pressure is reduced in the process of increasing the drawing speed of optical fiber 11. On the other hand, when the drawing speed is stable, the tension of optical fiber 11 is maintained high, and thus the blowing pressure is increased. As a method of increasing the blowing pressure, for example, a method of increasing the inlet pressure or decreasing width W of gap 80 can be adopted.

For example, when optical fiber 11 having a fiber size of 250 μm is floated, width W of gap 80 is adjusted so that the entrance pressure is in an optimum range of 50 kPa to 200 kPa. In this case, the flow rate of the gas blown out from gap 80 of one contactless guide 20 may be 30 L/min to 150 L/min.

When the blowing pressure is adjusted to an appropriate value, first, in a state where a gas is allowed to flow at a constant flow rate, width W of gap 80 is reduced until the inlet pressure reaches a predetermined value (for example, 200 kPa). At this time, for example, width W of gap 80 may be reduced by bringing second flange 70 closer to first flange 30. Thereafter, width W of gap 80 is gradually increased until the blowing pressure reaches an optimum value (value at which optical fiber 11 appropriately floats). At this time, for example, width W of gap 80 may be increased by separating second flange 70 from first flange 30. This adjustment operation may be performed at any timing in the manufacturing process of optical fiber 11.

Contactless guide 20 according to the present modification has a seal member 168 as shown in FIG. 9. Seal member 168 seals at least one of the plurality of ejection ports 47 and prevents the gas from passing through ejection port 47. Seal member 168 may be made of an elastic material such as resin, as in the case of seal member 68. Seal member 168 has an elongated shape and is fitted into a region of a part of buffer groove 51 to close ejection port 47. In the present modification, seal member 168 is fitted into a region of about two-thirds of buffer groove 51. The gas does not flow into some of second gas flow paths 46 in which ejection ports 47 are sealed by seal member 168, and the gas flows into other second gas flow paths 46 in which ejection ports 47 are not sealed.

In a direction (a radial direction of contactless guide 20) from central axis C toward the outer peripheral of contactless guide 20, most of seal member 168 is provided so as not to overlap optical fiber 11 passing through gap 80. In the example shown in FIG. 9, the portion of seal member 168 excluding the both end portions are provided so that the position in the circumferential direction does not overlap optical fiber 11 passed through gap 80. In addition, a pair of gas escape portions 184 through which the gas in buffer groove 51 flows out are provided between the both end portions of seal member 168 and optical fiber 11. Since the gas accumulated in buffer groove 51 smoothly flows out from gas escape portion 184, the gas of an excessively high pressure is not blown out from gap 80, and optical fiber 11 can be floated in a stable state. The shape of seal member 168 is not limited to the above-described shape. In the present modification, the plurality of ejection ports 47 are sealed by one continuous seal member 168, but the plurality of ejection ports 47 may be respectively sealed by a plurality of seal members 168 which are separated from each other, for example.

Here, the function and effect of contactless guide 20 applied to bottom roller 107 will be described. Conventionally, a roller that rotates by a bearing is used as bottom roller 107, but in this roller, a slight vibration (tilting vibration, amplitude 0.1 mm or so) may occur due to a deviation (for example, a deviation of about 30 μm to 50 μm) between the rotation axis and the verticality of the roller. This minute vibration propagates to optical fiber 11 (for example, diameter of 170 μm to 250 μm) guided by the bottom roller and bare optical fiber 10 connected thereto, and vibrates bare optical fiber 10 and the like. When bare optical fiber 10 and the like vibrates, bare optical fiber 10 which is being coated with the resin in coating device 5 is slightly shifted in the horizontal direction from the predetermined path, and causes the uneven thickness to the coating resin when optical fiber 11 is formed.

In contrast, in the present modification, contactless guide 20 is applied to bottom roller 107, and thus when optical fiber 11 coated with the resin is wound, the direction of optical fiber 11 is changed by bottom roller 107 which is a contactless roller of a non-rotary type. In this contactless roller, optical fiber 11 is floated by the gas, that is, optical fiber 11 is transported and wound in a contactless state without rotation. Therefore, the bottom roller does not rotate, and the direction of optical fiber 11 coated with the resin can be changed without contacting the roller, so that the vibration from the contactless roller is not propagated to bare optical fiber 10 and the like. In the case of the contactless roller, vibrations from various apparatuses (for example, winding device 9 and the like) located at the subsequent stage of the contactless roller are also attenuated by floating in the contactless roller, and are not easily propagated to bare optical fiber 10 and the like. As described above, according to the present modification, it is possible to manufacture an optical fiber in which the fluctuation of the uneven thickness of the coating is suppressed by appropriately coating the resin on bare optical fiber 10.

Although the modifications of the embodiments of the present disclosure have been described in detail, the present invention is not limited to the modifications described above, and can be applied to various embodiments. For example, the contactless roller applied to bottom roller 107 is not limited to the roller having the configuration shown in FIG. 2 and the like, and may be a contactless guide having a guide portion along the outer peripheral surface, around which a part of optical fiber 11 can be wound, and a plurality of ejection ports for blowing out gas for floating optical fiber 11 may be provided in the guide portion. Further, in the case where a roller other than bottom roller 107, for example, another roller is further provided between coating device 5 and winding device 9, the roller may be a contactless roller of a non-rotary type as described above.

### REFERENCE SIGNS LIST

1, 101 manufacturing apparatus
2 optical fiber preform
3 drawing furnace
4, 104 cooling device
5 coating device
6 curing device
7, 107 bottom roller
8 pulling roller
9 winding device
10 bare optical fiber
11 optical fiber
20, 20A, 20B, 20C, 20D, 20E, 20F, 20G contactless guide
30 first flange
31, 71 disc portion
31a, 71a hole
31b, 71b screw hole
32, 72 peripheral wall portion
32a, 72a outer peripheral surface
32b, 72b inner peripheral surface
33 first housing portion
40 inner member
41 main body portion
42 shaft portion
42a end surface
42b opening
43 columnar portion
44 first gas flow path
45 flow path branching portion
45a inner peripheral surface
46 second gas flow path
47 ejection port
50 first columnar surface
51 buffer groove
52 second columnar surface
54 first groove portion
54a 56a bottom surface
54b 56b side surface
56 second groove portion
57 plate housing portion
57a inner peripheral surface
58 inner side surface
58a screw hole
60 plate
61 first side surface
61a third groove portion
62 second side surface
63 outer peripheral surface
64 through hole
65 first sealing member
66 second sealing member
67 third sealing member
68, 168 seal member
70 second flange
73 second housing portion
80 gap
81, 181 wire inlet portion
82, 182 wire outlet portion
84, 184 gas escape portion
90, 91 screw
A region
C central axis
D1 winding diameter
P virtual point
S inner space
T arrow
W width

What is claimed is:

1. A contactless guide comprising:
an inner member having a plurality of ejection ports capable of ejecting a gas in an outer peripheral surface; and
a first flange and a second flange housing the inner member so as to sandwich the inner member in a first direction intersecting with an ejection direction of the gas ejected from the plurality of ejection ports,
wherein at least one of the first flange and the second flange is attached to the inner member such that a gap through which the gas ejected from the plurality of ejection ports passes is provided between an outer edge portion of the first flange and an outer edge portion of the second flange, and
wherein at least one of the first flange and the second flange is movable in a direction in which a width of the gap is changed.

2. The contactless guide according to claim 1,
wherein the outer peripheral surface of the inner member has a buffer groove extending in a circumferential direction of the outer peripheral surface,
wherein the plurality of ejection ports are provided in a bottom portion of the buffer groove, and
wherein the buffer groove is spatially connected to the gap in the ejection direction.

3. The contactless guide according to claim 1,
wherein the inner member has a disc shape and has a gas supply portion to which the gas is supplied from an outside and a plurality of gas flow paths connecting the gas supply portion with the plurality of ejection ports,
wherein the gas supply portion is located in a central portion of the inner member,
wherein the plurality of gas flow paths are provided radially from the gas supply portion to the plurality of ejection ports, and
wherein the plurality of ejection ports are located in a circumferential direction of the outer peripheral surface.

4. The contactless guide according to claim 3,
wherein each of the gas flow paths has a circular cross-section, and an inner diameter on a side of the ejection port is larger than an inner diameter on a side of the gas supply portion.

5. The contactless guide according to claim 1,
wherein the outer peripheral surface of the inner member includes a first columnar surface and a second columnar surface located with the plurality of ejection ports interposed therebetween in the first direction,
wherein the first flange has a first housing portion defined by an inner peripheral surface facing the first columnar surface when housing the inner member,
wherein the second flange has a second housing portion defined by an inner peripheral surface facing the second columnar surface when housing the inner member, and
wherein a sealing member is provided between the first columnar surface and the inner peripheral surface of the first housing portion, and a sealing member is provided between the second columnar surface and the inner peripheral surface of the second housing portion.

6. The contactless guide according to claim 1, further comprising:
a seal member sealing at least one of the plurality of ejection ports.

7. The contactless guide according to claim 1,
wherein at least one of a surface of the outer edge portion of the first flange and a surface of the outer edge portion of the second flange defining the gap has a Vickers hardness of 800 HV or more.

8. A method of manufacturing an optical fiber using the contactless guide according to claim 1, the method comprising:
melting an optical fiber preform and drawing a bare optical fiber;
cooling the bare optical fiber; and
coating the bare optical fiber with a resin to form an optical fiber,
wherein the cooling passes the bare optical fiber through the gap of the contactless guide, blows the gas ejected from the ejection ports against the bare optical fiber to float the bare optical fiber, and changes a direction of the bare optical fiber with the contactless guide serving as an axis.

9. The method of manufacturing an optical fiber according to claim 8,
wherein at least one of the first flange and the second flange is moved to adjust the width of the gap.

10. A manufacturing apparatus for an optical fiber using the contactless guide according to claim 1, comprising:
a melting device configured to melt an optical fiber preform in order to draw a bare optical fiber from the optical fiber preform;
a cooling device configured to cool the bare optical fiber; and
a coating device configured to coat the bare optical fiber with a resin to form an optical fiber,
wherein the cooling device is a device configured to pass the bare optical fiber through the gap of the contactless guide, blow the gas ejected from the ejection ports against the bare optical fiber to float the bare optical fiber, and cool the bare optical fiber.

11. A method of manufacturing an optical fiber using the contactless guide according to claim 1, the method comprising:
melting an optical fiber preform and drawing a bare optical fiber;
coating the bare optical fiber with a resin to form an optical fiber; and
changing a direction of the optical fiber using a bottom roller, and winding the optical fiber using a winding device,
wherein the bottom roller is the contactless guide.

12. The method of manufacturing an optical fiber according to claim 11, further comprising:
measuring a drawing tension,
wherein the winding adjusts the width of the gap of the contactless guide based on the measured drawing tension, and winds the optical fiber via the contactless guide.

13. The method of manufacturing an optical fiber according to claim 11, further comprising:
measuring a fiber diameter of the optical fiber,
wherein the winding adjusts the width of the gap of the contactless guide based on the measured fiber diameter, and winds the optical fiber via the contactless guide.

14. A manufacturing apparatus for an optical fiber using the contactless guide according to claim 1, comprising:
a melting device configured to melt an optical fiber preform in order to draw a bare optical fiber from the optical fiber preform;
a cooling device configured to cool the bare optical fiber;
a coating device configured to coat the bare optical fiber with a resin to form an optical fiber;
a winding device configured to wind the optical fiber; and
a bottom roller located between the coating device and the winding device in a path through which the optical fiber passes and configured to change a direction of the optical fiber,
wherein the bottom roller is the contactless guide.
